(19) United States
(12) Patent Application Publication
(10) Pub. No.: US 2021/0150078 A1
(43) Pub. Date: May 20, 2021

(54) RECONSTRUCTING AN OBJECT

(71) Applicant: Siemens Aktiengesellschaft, Munich (DE)

(72) Inventors: Vinay Ramanath, Bengaluru (IN); Almambet Iskakov, Charlotte, NC (US); Anant Kumar Mishra, Charlotte, NC (US)

(21) Appl. No.: 17/047,095

(22) PCT Filed: Aug. 20, 2018
(86) PCT No.: PCT/US2018/047016

§ 371 Date: Oct. 13, 2020

Related U.S. Application Data
(60) Provisional application No. 62/659,315, filed on Apr. 18, 2018.

(51) Int. Cl. G06F 30/10; G06F 30/27; G06T 17/00

(52) U.S. Cl. CPC G06F 30/10; G06F 2111/20; G06T 17/00; G06F 30/27

(57) ABSTRACT

In one example implementation according to aspects of the present disclosure, a computer-implemented method includes identifying, by a processing device, a transition feature of the object based at least in part on point cloud data corresponding to the object. The method further includes performing, by the processing device, a geometric analysis on the transition feature of the object based at least in part on a curvature deviation. The method further includes generating a fitted parametric surface for the object based at least in part on the transition feature of the object and results of the geometric analysis on the transition feature of the object.

### BACKGROUND

The present invention generally relates to computer-aided design, and more specifically, to reconstructing an object.

Computer-aided design (CAD) involves the use of a processing system (i.e., a computer) to aid in digitally creating, modifying, and visualizing designs of an object, such as an object, machine, or device, or a component thereof. In some situations, it is desirable to scan, using a three-dimensional scanner, an object to enable the object to be represented in a digital form. The object can then be digitally modified and/or visualized in a CAD software program.

### SUMMARY

Embodiments of the present invention are directed to a computer-implemented method for reconstructing an object. A non-limiting example of the computer-implemented method includes identifying, by a processing device, a transition feature of the object based at least in part on point cloud data corresponding to the object. The method further includes performing, by the processing device, a geometric analysis on the transition feature of the object based at least in part on a curvature deviation. The method further includes generating a fitted parametric surface for the object based at least in part on the transition feature of the object and results of the geometric analysis on the transition feature of the object.

Embodiments of the present invention are directed to a system. A non-limiting example of the system includes a memory comprising computer readable instructions and a processing device for executing the computer readable instructions for performing a method for reconstructing an object. A non-limiting example of the method includes identifying, by a processing device, a transition feature of the object based at least in part on point cloud data corresponding to the object. The method further includes performing, by the processing device, a geometric analysis on the transition feature of the object based at least in part on a curvature deviation. The method further includes generating a fitted parametric surface for the object based at least in part on the transition feature of the object and results of the geometric analysis on the transition feature of the object.

Embodiments of the invention are directed to a computer program product. A non-limiting example of the computer program product includes a computer readable storage medium having program instructions embodied therewith. The program instructions are executable by a processor to cause the processor to perform a method for reconstructing an object. A non-limiting example of the method includes identifying, by a processing device, a transition feature of the object based at least in part on point cloud data corresponding to the object. The method further includes performing, by the processing device, a geometric analysis on the transition feature of the object based at least in part on a curvature deviation. The method further includes generating a fitted parametric surface for the object based at least in part on the transition feature of the object and results of the geometric analysis on the transition feature of the object.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of a processing system for implementing the techniques described herein according to aspects of the present disclosure;

FIG. 2A depicts point cloud data according to one or more embodiments described herein;

FIG. 2B depicts a facet surface according to one or more embodiments described herein;

FIG. 2C depicts a parametric surface according to one or more embodiments described herein;

FIG. 3 depicts a deviation between the actual physical surface and a fitted cad surface according to one or more embodiments described herein.

FIG. 4 depicts an object having transition features according to one or more embodiments described herein;

FIG. 5 depicts a fitted parametric surface, point cloud data, and control vertices for parametric curve fitting according to one or more embodiments described herein;

FIG. 6 depicts a distance deviation between the PC data and the fitted parametric surface according to one or more embodiments described herein;

FIGS. 7A, 7B, and 7C depict an example technique for two-dimensional representation of a surface using normal vector orientation in space according to one or more embodiments described herein;

FIG. 8A depicts a representation of a planar surface having normal vectors extending therefrom according to one or more embodiments described herein;

FIG. 8B depicts an orientation distribution of the feature of FIG. 8A according to one or more embodiments described herein;

FIG. 8C depicts a representation of a smooth corner feature having normal vectors extending therefrom according to one or more embodiments described herein;

FIG. 8D depicts an orientation distribution of the feature of FIG. 8C according to one or more embodiments described herein;

FIG. 9 depicts an object having various transition features, each of the transition features having an orientation distribution associated therewith, according to one or more embodiments described herein;

FIG. 10 depicts a table of features and associated values according to one or more embodiments described herein;

FIG. 11 depicts a flow diagram of a method for classifying transition features according to one or more embodiments described herein;

FIG. 12 depicts STL data of an object having classified transition features according to one or more embodiments described herein;

FIG. 13 illustrates such an example of special distributions according to one or more embodiments described herein;

FIG. 14 depicts a block diagram of a supervised learning technique according to one or more embodiments described herein;

FIG. 15A depicts a conventional representation of an object using detected primitives determined using conventional approaches;

FIG. 15B depicts a non-conventional, improved representation of the object according to one or more embodiments described herein;

FIG. 16 depicts a curvature deviation metric approach to geometric analysis according to one or more embodiments described herein;

FIG. 17 depicts a plot of an object having a low to high confidence fits represented by a color-coded confidence scale based on the curvature similarity according to one or more embodiments described herein;

FIG. 18A depicts a facet surface, FIG. 18B depicts a fitted parametric surface, and FIG. 18C depicts an overlay surface that is the overlay of the facet surface and the fitted parametric surface, according to one or more embodiments described herein;

FIG. 19 depicts a flow diagram of a method for reconstructing an object according to examples of the present disclosure; and

FIG. 20 depicts a block diagram of a processing system for implementing the techniques described herein.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of the invention, the technical solutions described herein solve the technical problem concerned with accurate reconstruction of geometric surfaces, including but not limited to in the area of feature identification, extraction, curvature estimation, interactive visualization, and optimization semantics for geometry surface creation. One of the main advantages of the present techniques is that prior knowledge of geometry is not necessarily required to implement the technical solutions described herein.

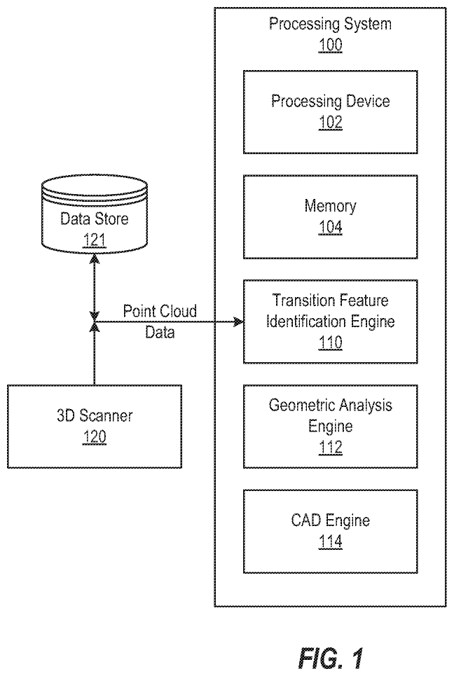

Turning now to a more detailed description of aspects of the present invention, FIG. 1 depicts a block diagram of a processing system 100 for computer aided design (CAD) reconstruction of an object according to aspects of the present disclosure. The processing system 100 includes a processing device 102, a memory 104, a transition feature identification engine 110, a geometric analysis engine 112, and a CAD engine 114. According to one or more embodiments described herein, the transition feature identification engine 110 identifies a transition feature of an object based at least in part on point cloud data corresponding to the object. The point cloud data can be received from a 3D scanner 120, from a data store 121, or from another suitable source. The geometric analysis engine 112 performs a geometric analysis on the transition feature of the object based at least in part on a curvature deviation. The CAD engine 114 generates a fitted CAD surface for the object based at least in part on the transition feature of the object and results of the geometric analysis on the transition feature of the object. The features and functionality of the feature identification engine 110, the geometric analysis engine 112, and the CAD engine 114 are further described herein.

The various components, modules, engines, etc. described regarding FIG. 1 can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) described herein can be a combination of hardware and programming. The programming can be processor executable instructions stored on a tangible memory, and the hardware can include the processing device 102 for executing those instructions. Thus a system memory (e.g., memory 104) can store program instructions that when executed by the processing device 102 implement the engines described herein. Other engines can also be utilized to include other features and functionality described in other examples herein.

According to one or more embodiments described herein, the feature identification engine 110, the geometric analysis engine 112, and/or the CAD engine 114 can be implemented on the processing system 100. Additionally, a cloud computing system can be in wired or wireless electronic communication with one or all of the elements of the processing system 100. Cloud computing can supplement, support, and/or replace some or all of the functionality of the elements of the processing system 100. Additionally, some or all of the functionality of the elements of the processing system 100 can be implemented as a node of a cloud computing system. A cloud computing node is only one example of a suitable cloud computing node and is not intended to suggest any limitation as to the scope of use or functionality of embodiments described herein.

According to one or more embodiments described herein, the engines 110, 112, 114 can also be implemented as so-called classifiers. In one or more embodiments of the invention, the features of the various engines/classifiers (110, 112, 114) described herein can be implemented on the processing system 100 shown in FIG. 1, or can be implemented on a neural network (not shown). In embodiments of the invention, the features of the engines/classifiers 110, 112, 114 can be implemented by configuring and arranging the processing system 100 to execute machine learning (ML) algorithms. In general, ML algorithms, in effect, extract features from received data (e.g., inputs to the engines 110, 112, 114) in order to “classify” the received data. Examples of suitable classifiers include but are not limited to neural networks, support vector machines (SVMs), logistic regression, decision trees, hidden Markov Models (HIVIMs), etc. The end result of the classifier's operations (i.e., the “classification”) is to predict a class for the data. The ML algorithms apply machine learning techniques to the received data in order to, over time, create/train/update a unique “model.” The learning or training performed by the engines/classifiers 110, 112, 114 can be supervised, unsupervised, or a hybrid that includes aspects of supervised and unsupervised learning. Supervised learning is when training data is already available and classified/labeled. Unsupervised learning is when training data is not classified/labeled so must be developed through iterations of the classifier. Unsupervised learning can utilize additional learning/training methods including, for example, clustering, anomaly detection, neural networks, deep learning, and the like.

According to one or more embodiments described herein where the engines/classifiers 110, 112, 114 are implemented as neural networks, a resistive switching device (RSD) can be used as a connection (synapse) between a pre-neuron and a post-neuron, thus representing the connection weight in the form of device resistance. Neuromorphic systems are interconnected processor elements that act as simulated “neurons” and exchange “messages” between each other in the form of electronic signals. Similar to the so-called “plasticity” of synaptic neurotransmitter connections that carry messages between biological neurons, the connections in neuromorphic systems such as neural networks carry electronic messages between simulated neurons, which are provided with numeric weights that correspond to the strength or weakness of a given connection. The weights can be adjusted and tuned based on experience, making neuromorphic systems adaptive to inputs and capable of learning. For example, a neuromorphic/neural network for handwriting recognition is defined by a set of input neurons, which can be activated by the pixels of an input image. After being weighted and transformed by a function determined by the network's designer, the activations of these input neurons are then passed to other downstream neurons, which are often referred to as “hidden” neurons. This process is repeated until an output neuron is activated. Thus, the activated output neuron determines (or “learns”) which character was read. Multiple pre-neurons and post-neurons can be connected through an array of RSD, which naturally expresses a fully-connected neural network.

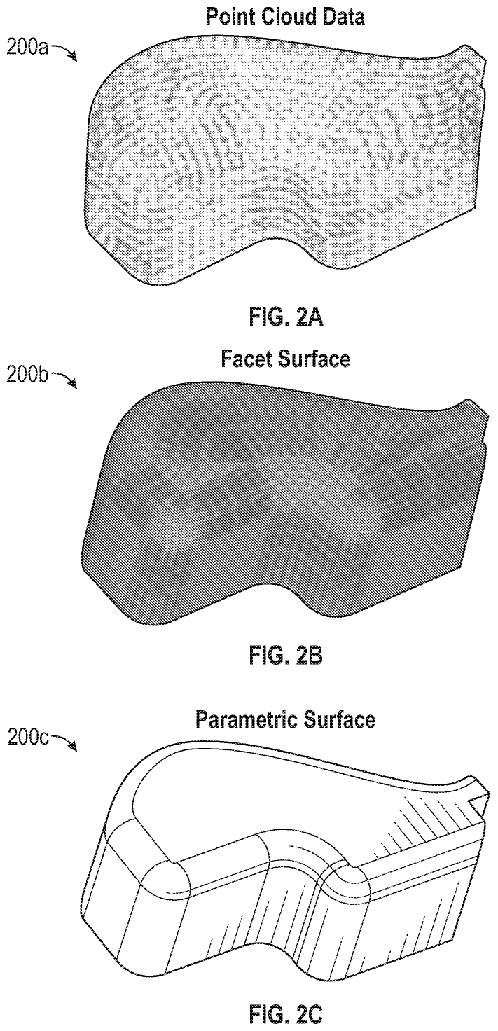

One example of a reconstruction flow is depicted in FIGS. 2A, 2B, and 2C. In particular, FIG. 2A depicts point cloud data 200a, FIG. 2B depicts a facet surface 200b, and FIG. 2C depicts a parametric surface 200c. The process begins by obtaining sampled point cloud (PC) data 200a by scanning a physical object. The next step is to analyze the point cloud data 200a and create a facet surface 200b, usually in a stereo lithography (STL) format. STL creates planar surfaces between the point cloud data points. Facet surface 200b is also referred to as STL throughout this description. The third step is to create a fully parametric surface (or solid) 200c from the facet surface 200b. The fully parametric surface 200c is also referred to as a CAD surface.

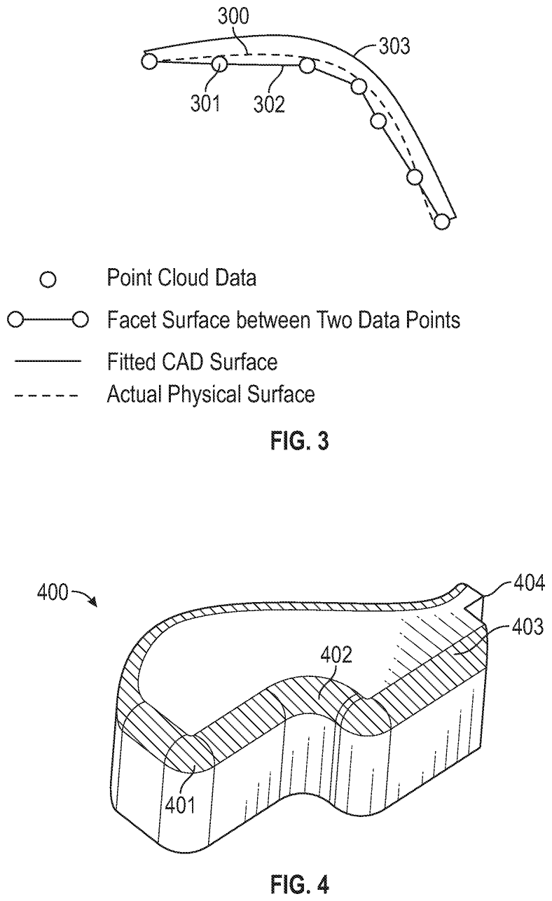

The technical solutions described herein address the technical problem of deviation between the geometry of the actual physical object surface and the recreated CAD surface. The concept of the problem is visualized in FIG. 3 as relating to a 2-dimensional (2D) example. In particular, FIG. 3 depicts a deviation between an actual physical surface 300 of an object and a fitted CAD surface 303 of the object. The PC data 301 is treated as ground truth of the physical surface 300, although deviations can exist as with any experimental measurements. The STL surface 302 (i.e., facet surface between two data points) connects the PC data 301 but lacks curvature. The fitted CAD surface 303 has curvature but may deviate from the PC data 301 as shown. The problem with the fitted CAD surface 303 is that it only utilizes a single distance measure for fitting a best CAD surface to the PC data 301. As a result, the fitted CAD surface 303 fails to accurately model the actual physical surface 300.

This technical problem is amplified by the fact that more challenging to reconstruct features (e.g., convex/concave fillet, sharp corner, edge fillet, etc.) are treated the same as easy-to-model features (e.g., a plane, etc.). Features that are more difficult to reconstruct from PC data are usually in transition areas between easy-to-model features (e.g., a fillet between two planes). These features are referred to as “transition features.” Examples of transition features are depicted in FIG. 4. In particular, FIG. 4 depicts an object 400 having transition features according to one or more embodiments described herein. The object 400 includes various transition features, such as a convex fillet 401, a concave fillet 402, an edge fillet 403, and a sharp corner 404.

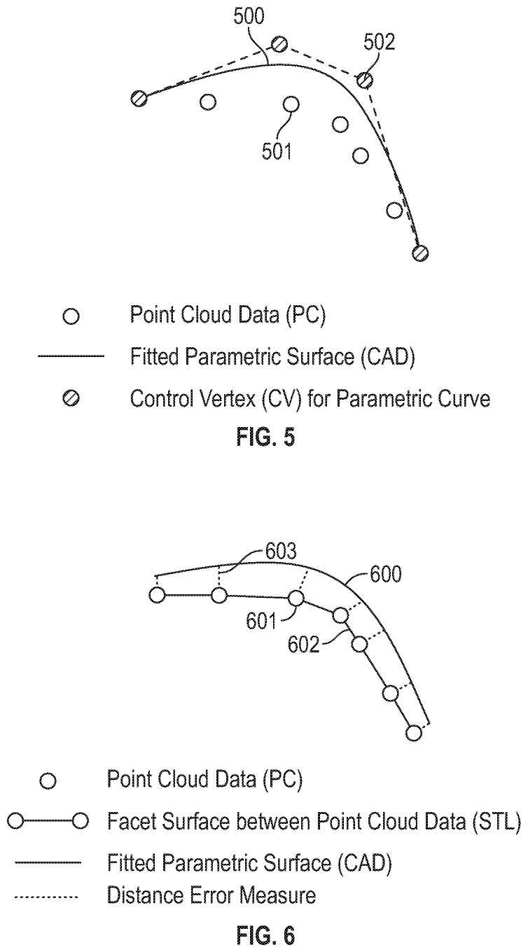

Existing approaches for solving the technical problem described herein are inadequate. For example, existing approaches rely on manual creation of CAD surfaces by engineers. This approach is inefficient and prone to inaccuracies due to human error, for example. Other approaches for CAD surface recreation are parametric splice surfaces. Adjustable parameters in splice surfaces usually include degree of spline, a location of control vertices (CVs), a smoothness parameter, a number of surface patches, etc. An illustration of a fitted parametric curve in 2D is depicted in FIG. 5. Although this example is depicted in 2D for conceptual purpose, the same can be directly expanded in 3D. In particular, FIG. 5 depicts a fitted parametric surface 500, point cloud data 501, and control vertices 502 for parametric curve fitting.

Techniques for reducing error for reconstructed CAD surfaces are based on several quantitative and qualitative evaluations. The prevailing quantitative evaluation is based on distance deviation between PC data and fitted CAD surface, as illustrated in FIG. 6. This figure depicts a distance deviation 603 (i.e., a distance error measure) between the PC data 601 and the fitted parametric surface 600. Also depicted are facet surfaces 602 between the PC data 601. The distance deviation 603 metric alone is not sufficient for capturing the accuracy of fit for all topological features. Particularly, the distance deviation 603 may lack the ability to capture the underlying curvature (or several successive curvatures) of a scanned object. In other words, the distance deviation methods are better suited to planar regions or regions that do not have abrupt changes in topology (e.g., transition features), which is common in many engineering applications. It should also be noted that the distance deviation 603 does not take into account the global feature of the object. For example, the distance deviation 603 treats a fillet area the same as a sharp edge, which is not necessarily true.

The qualitative evaluation is based on a human operator's assessment of geometrical similarity between target data points and a fitted surface as well as the operator's own interpretation of underlying geometrical features. The operator's evaluation is also based on his/her domain knowledge, which can vary among operators. This can result in inconsistencies, inaccuracies, and inefficiencies when recreating an object.

Turning now to an overview of the aspects of the invention, one or more embodiments described herein address the above-described shortcomings of the prior art by utilizing the geometrical properties of point cloud data and stereo lithography data to aid the generation of a more accurate CAD surface. The described techniques identify transition features and perform geometric analysis of transaction features to generate the more accurate CAD surface.

Transition feature identification is performed by the transition feature identification engine 110 and includes identifying transition features, which are predominantly curved or abrupt areas that connect two or more planar surface patches. Transition features are identified using an automated, data-driven classification technique. Initially, a training set of features is developed using a computation simulation, which populates a library (stored in a data store, such as the data store 121) that contains geometric characteristics of many possible transition features. A machine learning algorithm utilizes this prior training set of features to classify new point cloud data from point cloud scans (e.g., stored in the data store 121, received from the 3D scanner 120, etc.). After identification of features, the library of features is updated with the classified features. Additionally, according to one or more embodiments described herein, the classified features that do not belong to a certain class (e.g., fillet, chamfer, etc.) are classified or removed from library, for example, by expert opinion of the user.

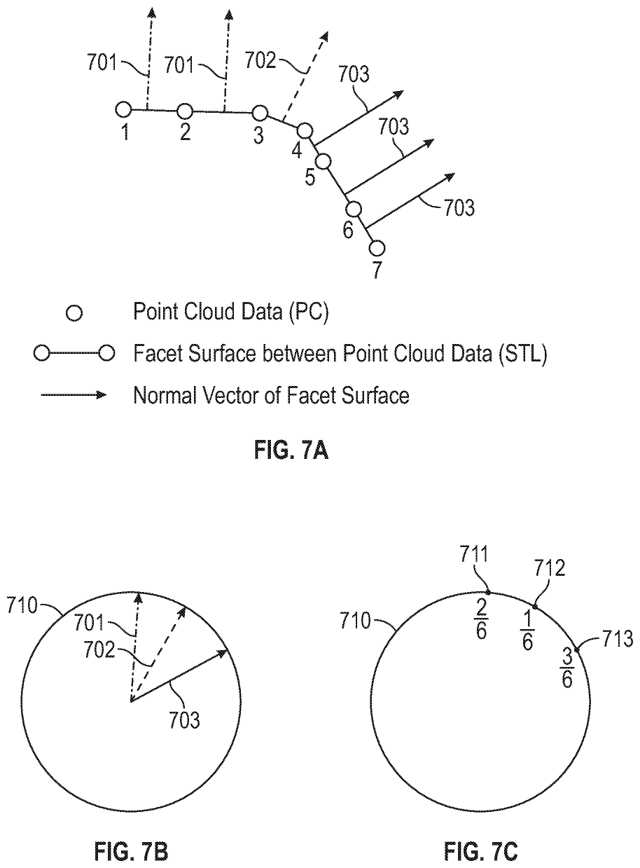

The transition feature identification engine 110 first performs characterization of geometrical features. To identify a feature by geometric characteristics in point cloud data and STL data, the transition feature identification engine 110 utilizes surface orientation information. A surface can be defined by its normal vector orientation in space, as shown for a 2D example in FIGS. 7A, 7B, and 7C. For example, in FIG. 7A, an STL surface (e.g., the facet surface between point cloud data) and the normal vectors 701, 702, 703 defining each segment are shown. As shown, there are three unique normal vectors-vectors 701, vector 702, and vectors 703. Each of the normal vectors is perpendicular to the facet surface 705 associated therewith and has a length of one unit.

In FIG. 7B, the unique orientations of the STL surface are displayed on a unit circle 710. That is, one vector representing each of the unique orientations is depicted.

In FIG. 7C, the representation of the unique orientations from FIG. 7B is simplified by plotting points 711, 712, 713 of unique orientations on the unit circle 710 and denoting the frequency of each vector orientation. For example, the point 711 represents the orientation of the vectors 701; the point 712 represents the orientation of the vectors 70; and the point 713 represents the orientation of the vectors 703. The frequency of each vector orientation in represented as a ratio of the total vectors for the particular orientation versus the total number of vectors. For example, the point 711 has a frequency of 2/6 (i.e., two vectors at point 711 to six total vectors).

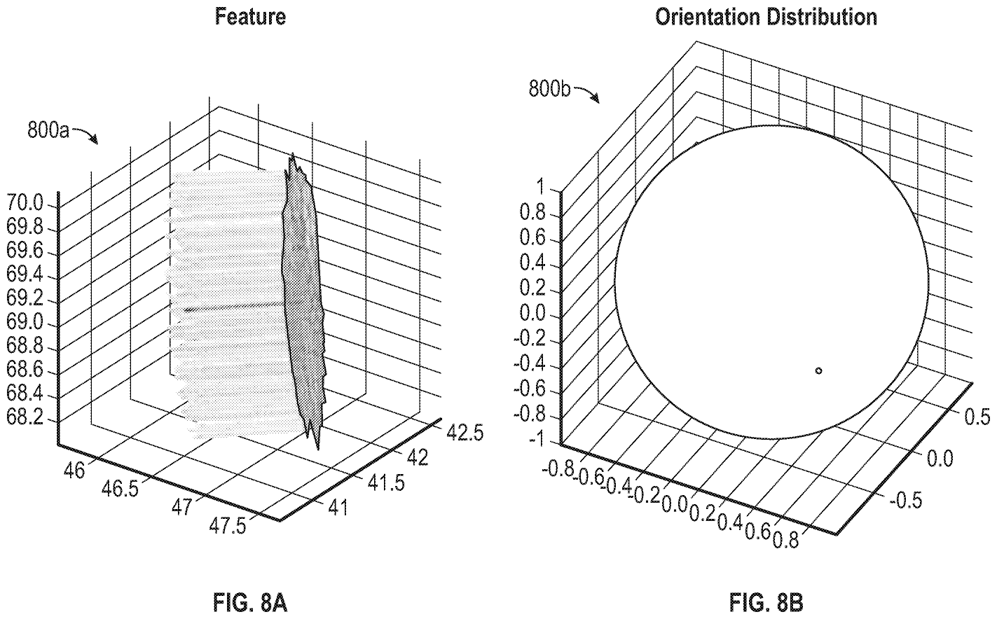

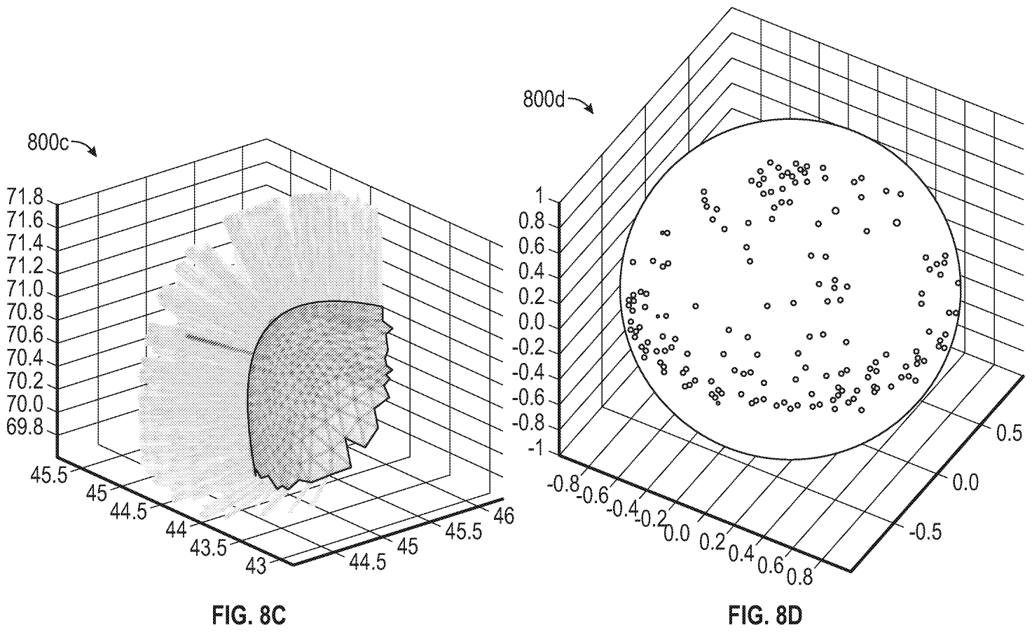

The same concept can be expanded in three-dimensions and is shown for a planar and a smooth corner features in FIGS. 8A and 8C. In particular, FIG. 8A depicts a representation 800a of a planar surface having normal vectors extending therefrom according to one or more embodiments described herein, and FIG. 8C depicts a representation 800c of a smooth corner feature having normal vectors extending therefrom according to one or more embodiments described herein.

The transition feature identification engine 110 plots the unique orientations for each of the surfaces of FIGS. 8A and 8C on a unit sphere since the surface normal vectors occupy a 3D space. This is shown in FIGS. 8B and 8D respectively as orientation distribution 800b and orientation distribution 800d. It is important to note that the surface normal orientations are collected around a radius “r” about a single reference surface vector, shown as a bold vector. The collected orientations for each of the features of FIGS. 8A and 8C are rotated by a calculated rotation that aligns the reference vector with [1,0,0] direction. This is done so that same types of features in different spatial locations yield the similar orientation distributions.

The orientation distributions 800b, 800d define the characteristics of various transition features and provide a distinctive orientation pattern as can be seen FIGS. 8B and 8D. For example, the planar feature of FIG. 8A has all normal vectors aligned in one direction, and the single dot on the sphere of the orientation distribution 800b clearly shows that the probability for this orientation is 1. In the case of FIGS. 8C and 8D, the smooth corner feature of representation 800c includes a wide range of orientations of unit vectors as is shown in the orientation distribution 800d of FIG. 8D. The probability of the orientation distribution 800d is spread over a wider range compared to a planar feature orientation distribution 800b.

The transition feature identification engine 110 then utilizes a machine learning algorithm for automated classification and selection of transition features. The machine learning algorithm can be, for example, a classification algorithm, evidence based reasoning on feature identification (i.e., placing confidence intervals on results), and the like.

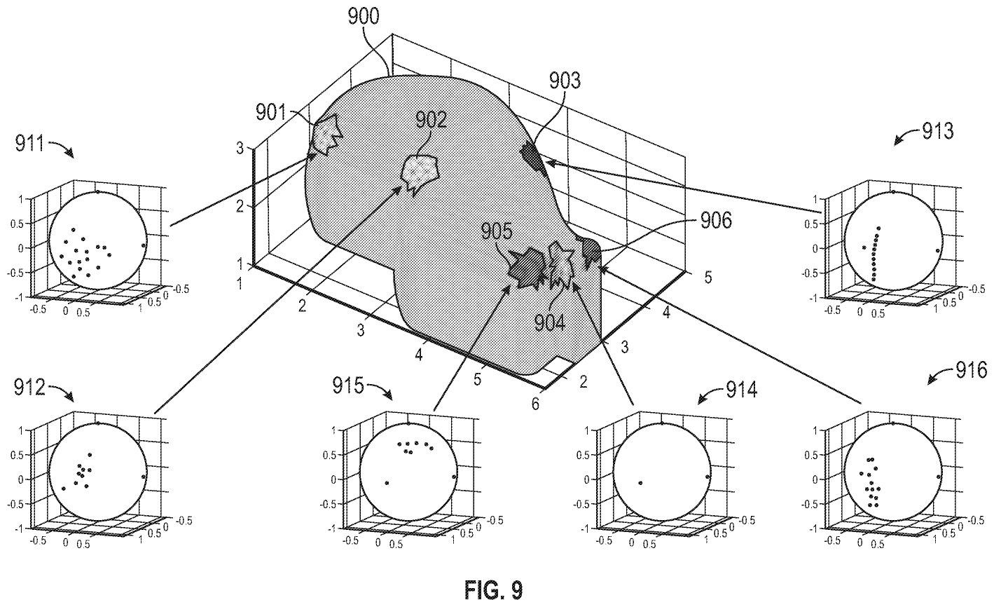

Once a library of simulated features is established from simulated or real scanned data, the transition feature identification engine 110 defines distribution metrics that correspond to each transition feature type. This problem can be solved using several classification approaches in the machine learning field. To provide an example, a simple classification approach is described that analyzes the angle deviation of normal surface vectors with respect to the reference surface vector for the generated shape depicted in FIG. 9. That is, the angle deviation is the angle between the single reference surface vector (shown as a bold vector in FIGS. 8A and 8C) and the normal surface vectors. Note that the angle deviation is only a small subset of available data from the orientation distribution.

FIG. 9 depicts an object 900 having various transition features, each of the transition features having an orientation distribution associated therewith. For example, the object 900 has transition features 901, 902, 903, 904, 905, 906, each having one of the orientation distributions 911, 912, 913, 914, 915, 916 associated therewith. The orientation distribution 911, associated with the transition feature 901, represents a convex fillet. The orientation distribution 912, associated with the transition feature 902, represents a concave fillet. The orientation distribution 913, associated with the transition feature 903, represents a smooth fillet. The orientation distribution 914, associated with the transition feature 904, represents a sharp corner. The orientation distribution 915, associated with the transition feature 905, represents a sharp corner with high noise. The orientation distribution 916, associated with the transition feature 906, represents a fillet and sharp corner.

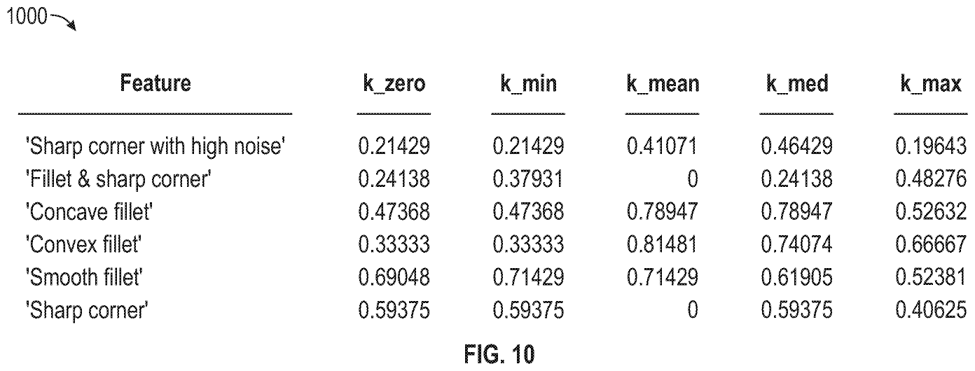

In the example of FIG. 9, the transition features 901-906 were determined using data generated and displayed in FIG. 10. Each transition feature has calculated angle deviations associated therewith, as shown in FIG. 10. These angle deviation values are useful for determining the transition feature type for an identified transition feature. For example, each transition feature includes a k_zero angle deviation value, a k_min (minimum) angle deviation value, a k_mean angle deviation value, a k_med (median) angle deviation value, and a k_max (maximum) angle deviation value. The k_zero angle deviation value is a fraction of vectors with orientations within ten degrees from the reference vector. The k_min angle deviation value is a fraction of vectors with orientations within 10 degrees of minimum deviation from the reference vector. The k_max angle deviation value is a fraction of vectors with orientations within 10 degrees of maximum deviation from the reference vector. The k_mean angle deviation value is a fraction of vectors with orientations within 10 degrees of average deviation from the reference vector. The k_med angle deviation value is a fraction of vectors with orientations within 10 degrees of median deviation from the reference vector. FIG. 10 depicts a table 1000 of features and associated values that are calculated by the transition feature identification engine 110.

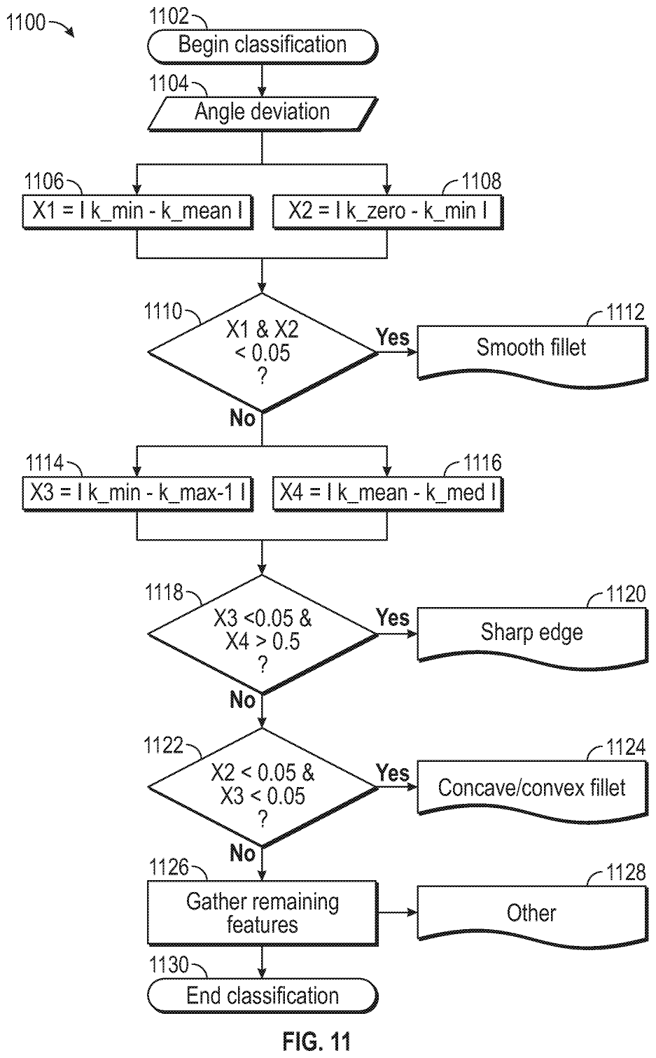

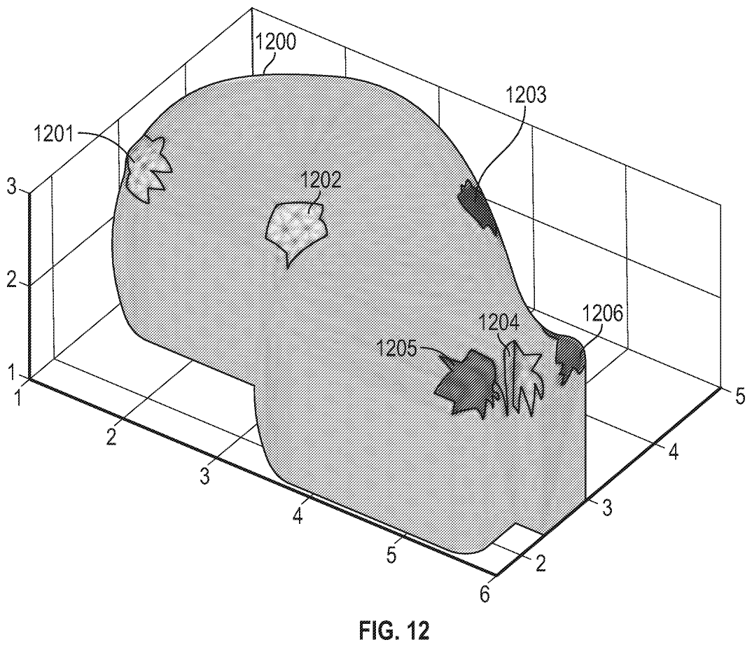

The angle deviation values of FIG. 10 can be classified based on a defined logic as depicted in the example flow diagram of FIG. 11. In particular, FIG. 11 depicts a flow diagram of a method 1100 for classifying transition features according to one or more embodiments described herein. The method 1100 can utilize the calculated angle deviations using the equations described above and the results depicted in the table 1000. In particular, the method 1100 utilizes the five angle deviation values of the table 1000 to classify transition features into one of four classes: smooth fillet, smooth fillet/corner, sharp edge, and other. The “concave/convex fillet” and “other” classes can be better classified by a machine learning algorithm trained by data as described herein. Also, as described herein, transition features can be further identified by the expert opinion of the user.

The method 1100 begins classification at block 1102. At block 1104, the transition feature identification engine 110 calculates angle deviations according to the equations used to derive the deviation values of the table 1000. At blocks 1106 and 1108, the transition feature identification engine 110 calculates values for parameters X1 and X2 as shown. At decision block 1110, the transition feature identification engine 110 determines whether X1 and X2 are less than a first threshold (e.g., 0.05). If so, the transition feature is determined to be a smooth fillet at block 1112; however, if not, the method 1100 continues to blocks 1114 and 1116.

At blocks 1114 and 1116, the transition feature identification engine 110 calculates values for parameters X3 and X4 as shown. At decision block 1118, the transition feature identification engine 110 determines whether X3 is less than the first threshold (0.05) and whether X4 is greater than a second threshold (e.g., 0.5). If so, the transition feature is determined to be a sharp edge at block 1120; however, if not, the method 1100 continues to decision block 1122.

At decision block 1122, the transition feature identification engine 110 determines whether X2 is less than the first threshold (e.g., 0.05) and whether X3 is less than the first threshold (e.g., 0.05). If so, the transition feature is determined to be a concave/convex fillet at block 1124; however, if not, the method 1100 continues to block 1126. At block 1126, any remaining transition features are gathered and determined to be “other” classification types at block 1128. The method 1100 terminates at block 1130. It should be appreciated that the technique described in FIG. 11 is only one of many methods that can be used for classification of transition features. It should also be appreciated that the thresholds described with respect to the method 1100 are merely examples and can differ in other implementations.

FIG. 12 depicts the results of the classification technique described in the method 1100 of FIG. 11. In particular, FIG. 12 depicts STL data 1200 of an object having classified transition features 1201, 1202, 1203, 1204, 1205, 1206 according to one or more embodiments described herein. The transition features 1201, 1202 represent smooth fillets/corners; the transition feature 1203 represents a smooth fillet; the transition feature 1204 represents a sharp edge; and the transition features 1205, 1206 represents other transition features.

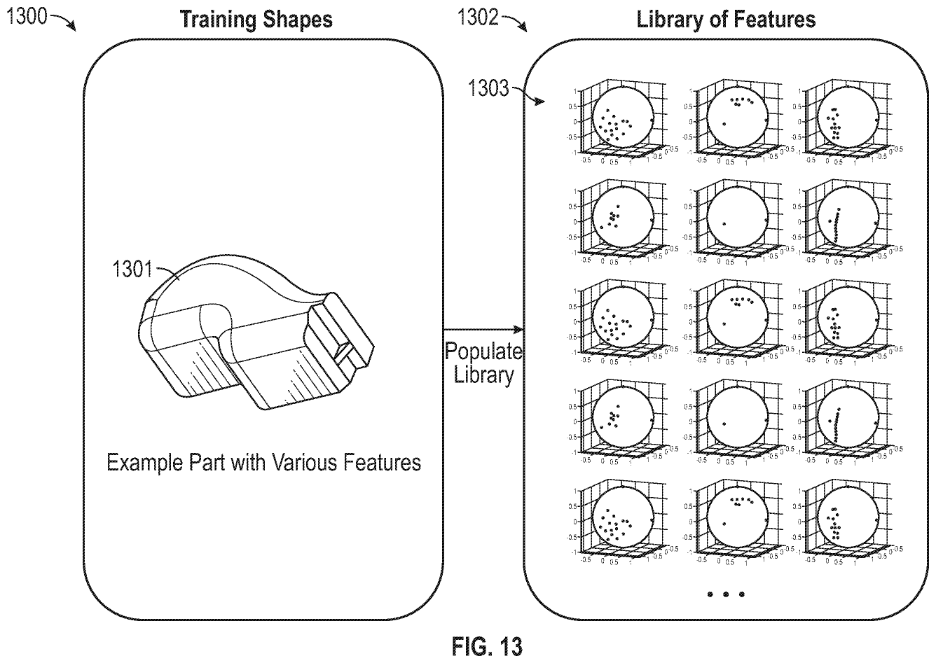

After the spatial distribution of features is classified by the method 1100 or another suitable classification technique, the transition feature identification engine 110 stores spatial distributions for the identified features in a library of features, such as in the data store 121. FIG. 13 illustrates such an example of spatial distributions. In particular, an example object 1301 with various features represents a training shape 1300 for which the transition feature identification engine 110 identifies and classifies transition features. The spatial distribution of features 1303 are stored in a library of features 1302 (e.g., in a data store 121). According to one or more embodiments described herein, a full orientation map with a large feature (variable) space is stored since a more advanced machine learning algorithm can later be implemented to classify features. Depending on the algorithm, the salient variables in the orientation map will be used to classify features (which are unknown in advance).

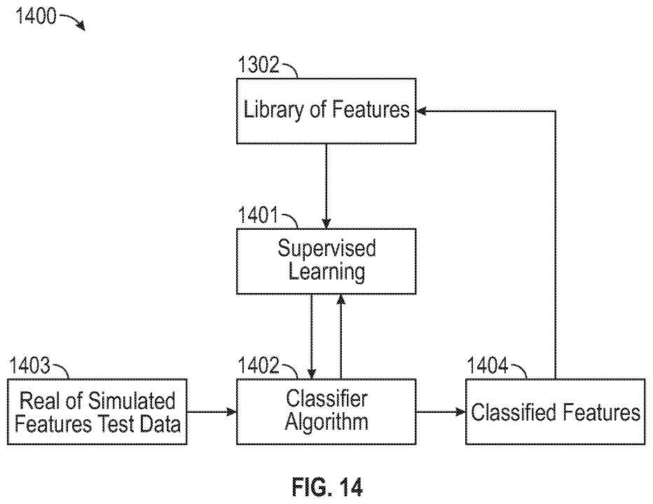

Once a trained classification model is implemented on real or simulated test data, the classified features populate back into the library of features 1302 for the training set. The transition feature identification engine 110 can perform a supervised learning technique to modify the library of features 1302 by updating database structuring of features, automatically updating features, incorporating expert opinions in feature selection, etc. FIG. 14 depicts a block diagram of a supervised learning technique 1400 according to one or more embodiments described herein. This technique enables the library of features 1302 to be expanded, for example, when a new geometry is analyzed. At block 1401, supervised learning occurs using data stored in the library of features 1302. A classifier algorithm (block 1402) classifies transition features (block 1404) using real or simulated features of test data (block 1403). This feedback loop retrains the supervised learning technique, which illustrates the data-driven nature of this technique.

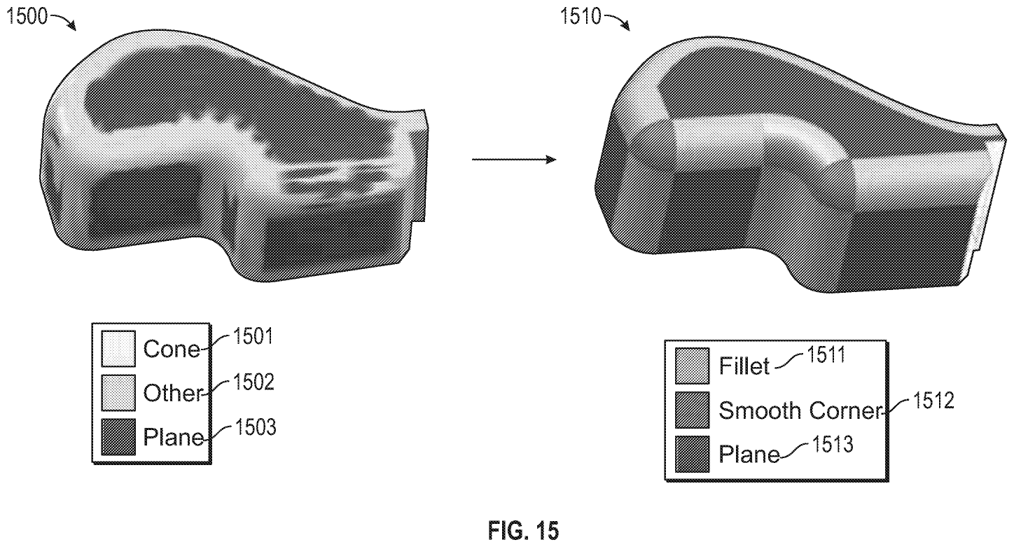

After the transition feature identification engine 110 identifies and classifies the transition features, a visual labelling to the object can be applied. An illustration is shown in FIG. 15B. In particular, FIG. 15A depicts a conventional representation 1500 of an object using detected primitives determined using conventional approaches. The repetition 1500 includes a cone region 1501, another region 1502, and a plane region 1503. FIG. 15B depicts a non-conventional, improved representation 1510 of the object according to one or more embodiments described herein. The representation 1510 incudes a fillet region 1511, a smooth corner region 1512, and a plane region 1513 The transition features of the improved representation 1510 can be identified and classified as fillets, smooth corners, etc. instead of “other” as done using the conventional techniques. That is, otherwise unclassified transition features are now properly classified by the feature detection techniques described herein, representing an improvement to transition feature and classification technologies.

Subsequent to transition feature identification, the geometric analysis engine 112 of the processing system 100 of FIG. 1 performs a geometric analysis by analyzing the curvature of identified transition features and utilizing this information as an error metric to perform surface fit. In this step, the pattern of surface curvature is captured in the PC data and STL data. This deviation of curvature is compared with the reconstructed surface at each PC data point and corresponding location on the fitted parametric surface (i.e., CAD) surface. In addition to the existing distance deviation, the curvature deviation is used in a loss function to optimize the fitted shape of the curvature deviation (i.e., CAD) surface. This loss function can be utilized to determine optimal locations of control vertices of the patch in transition features.

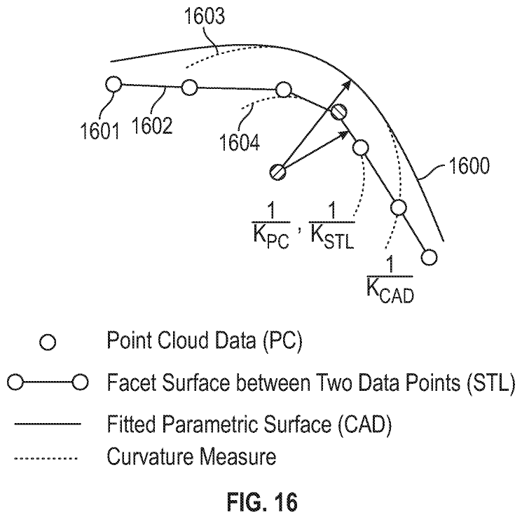

FIG. 16 depicts a curvature deviation metric approach to geometric analysis according to one or more embodiments described herein. FIG. 16 includes a fitted parametric (CAD) surface 1600 that is based on STL data. Facet surfaces 1602 connect point cloud data 1601 as shown. Curvature measures are also presented, with curvature measure 1603 representing the curvature of the fitted parametric (CAD) surface and curvature 1604 representing the curvature of the PL data and STL data. A curvature deviation metric (CDM) is calculated as the difference between the curvatures of PC data, STL data, and CAD data. The CDM in this two-dimensional example is a single number since in 2D, there is one curvature value “k.” However, in a three-dimensional case, two curvature values are computed—“k1” and “k2,” which are the maximum and minimum principal curvatures respectively. As described, the CDM is the difference between the curvature of PC data 1601 and the fitted parametric surface 1600 at a specific point of the PC data 1601 and can be written as the following expression:

CDM=K_{PC}−K_{CAD}

where K_{PC} is the curvature of the PC data 1601 at the specific point and K_{CAD} is the curvature of the fitted parametric surface 1600 at the specific point.

The geometric analysis engine 112 can performed a CDM-based optimization technique to minimize the CDM between the PC data 1601 and the fitted parametric surface 1600 at the specific point. To improve the fit of the fitted parametric surface 1600, the location of control vertices is determined by an optimization of an objective function that minimizes the error between the curvature of the PC data 1601 and the fitted parametric surface 1600. Such a function can be defined as follows:

l(κ(xᵢ|θ),κ_{PCi})=(κ(xᵢ|θ)−κ_{PCi})²

In this objective function, curvature of the PC data 1601 “K” is the target because it is the collected experimental locations “x.” The parameters “θ” are the locations on the control vertices of the fitted parametric surface 1600 and are the perturbed parameters in this optimization problem.

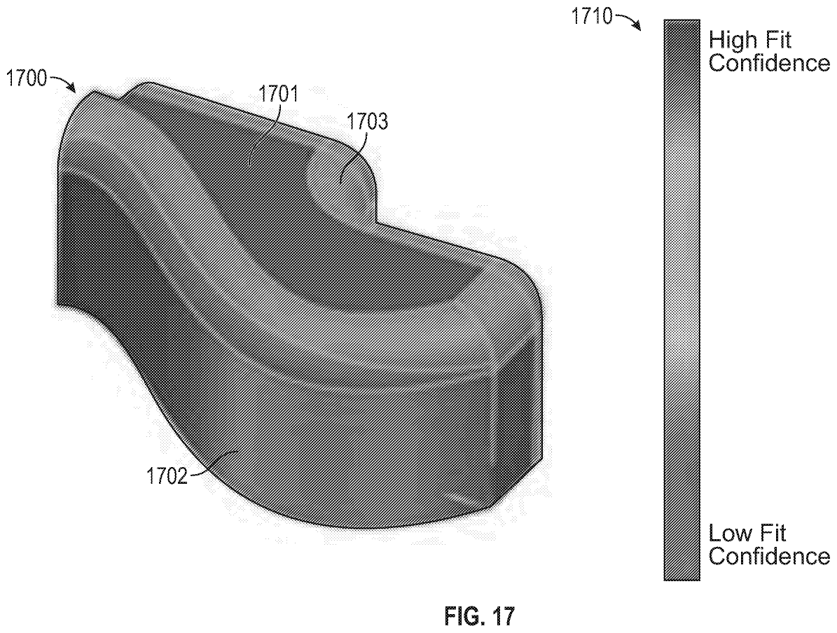

The CAD engine 114 of the processing system 100 of FIG. 1 generates a fitted parametric (i.e., computer-aided drawing) surface for the object based at least in part on the transition feature of the object and results of the geometric analysis on the transition feature of the object. The geometric analysis engine 112 can also generate a surface fit confidence index color map on the CAD surface. For example, after the CAD surface fit is performed, deviation of curvature between PC data, STL data, and the CAD surface is visualized on the part as depicted in FIG. 17. In particular, FIG. 17 depicts a plot 1700 of an object having a low to high confidence fits represented by a color-coded confidence scale 1710 based on the curvature similarity. For example, the plot 1700 includes low confidence regions 1703, medium confidence regions 1702, and high confidence regions 1701. This functionality is for visual and qualitative inspection, and is useful in determining the locations in which the curvature deviation is relatively low compared to curvature deviations that are relatively high. For example, the relatively low curvature (i.e., the medium confidence region 1702) and planar regions (i.e., the high confidence region 1701) are color-coded according to the confidence index of fit shown on the color-coded confidence scale 1710. Similarly, transition features (i.e., the low confidence region 1703) are colored with lower confidence index shown on the color-coded confidence scale 1710. The confidence index can be calculated on a relative confidence scale for a part or in a more global scale.

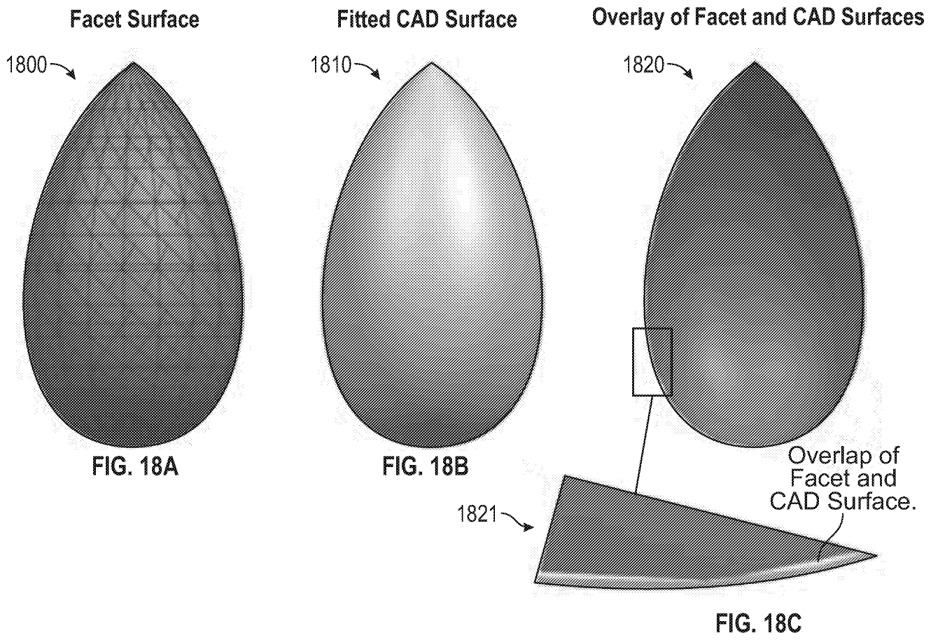

The geometric analysis engine 112 can also measure volumetric deviation of a fitted parametric surface. FIG. 18A depicts a facet surface 1800, FIG. 18B depicts a fitted parametric surface 1810, and FIG. 18C depicts an overlay surface 1820 that is the overlay of the facet surface 1800 and the fitted parametric surface 1810, according to one or more embodiments described herein. An additional measure of fit of CAD surface can be measured by the volumetric deviation of the CAD surface from PC data and STL data. The volumetric error measure is applied to water tight surfaces and bodies, for example. The volume of the facet surface 1800 can be calculated using the convex hull of the PC data points. The volume of the fitted parametric surface 1810 can be calculated numerically. The relative changes (i.e., difference) in volume is a useful and easy to interpret measure of error in the reconstruction problem. This difference is shown in the cutaway portion 1821 of the overlay surface 1820, with the space between the facet region and the fitted parametric surface region being the difference. According to one or more embodiments described herein, a relatively smaller difference in volume indicates a more accurate fit, while a relatively larger difference in volume indicates a less accurate fit.

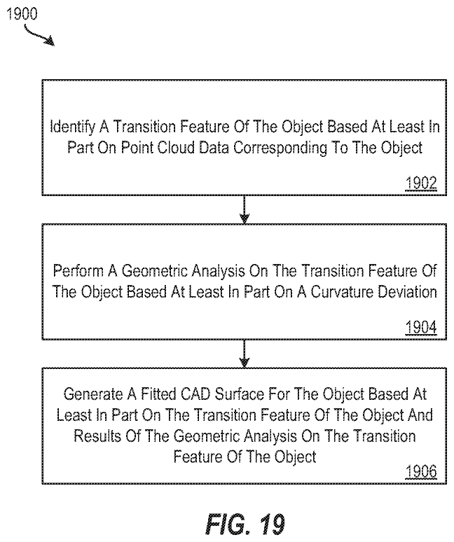

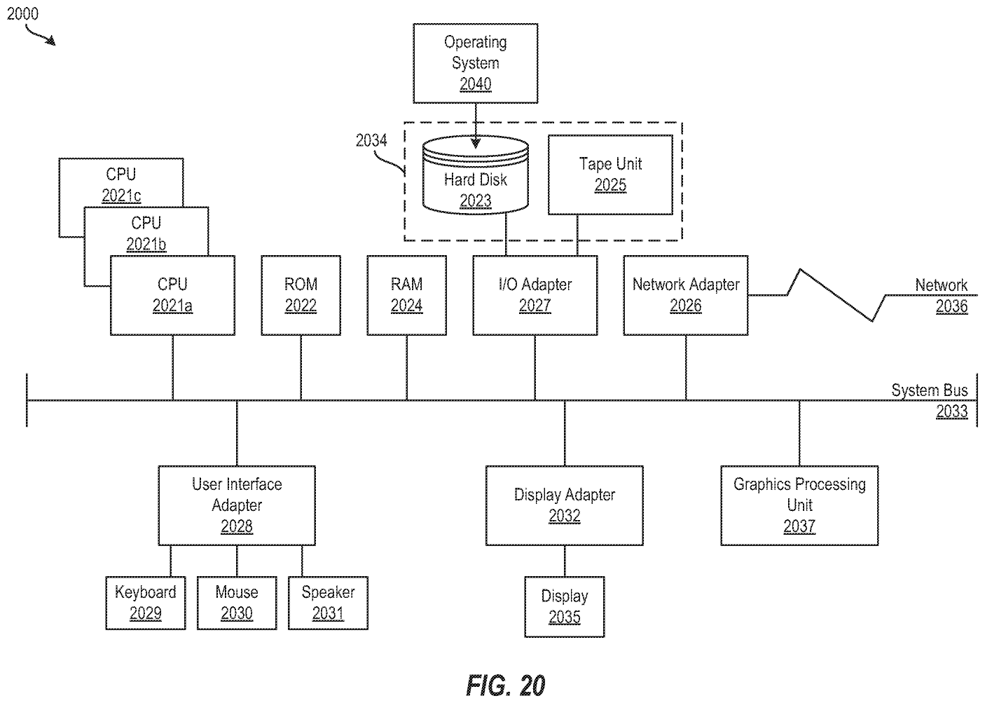

FIG. 19 depicts a flow diagram of a method 1900 for reconstructing an object according to examples of the present disclosure. The method 1900 can be performed by any suitable processing system and/or processing device, such as the processing system 100 of FIG. 1 and/or the processing system 2000 of FIG. 20, the processing device 102 of FIG. 1, the processor (i.e., the processing device) 2021 of FIG. 20, and/or combinations thereof. The blocks of the example method 1900 are now described with reference to the processing system 100 of FIG. 1.

At block 1902, the transition feature identification engine 110 identifies a transition feature of the object based at least in part on point cloud data corresponding to the object. Identifying a transition feature of the object can include determining an orientation and a frequency of at least one vector associated with a facet surface of the object. Further, identifying a transition feature of the object can include calculating an angle deviation value between at least one vector extending perpendicularly from a facet surface of the object relative to a normal vector extending perpendicularly from a reference point on the object. The angle deviation value can be one of a plurality of angle deviation values selected from the following: a zero angle deviation value, a minimum angle deviation value, a maximum angle deviation value, a mean angle deviation value, and a median angle deviation value. Identifying a transition feature of the object can also include classifying the transition feature of the object based at least in part on the angle deviation value. Classifying the transition feature can include classifying the transition feature as one of a smooth fillet, a smooth fillet/corner, a sharp edge, and other. Classifying the transition feature can also include comparing the angle deviation value to a plurality of threshold values. Further, identifying the transition feature of the object can include storing a spatial distribution for the transition feature in a library of transition features.

At block 1904, the geometric analysis engine 112 performs a geometric analysis on the transition feature of the object based at least in part on a curvature deviation. Performing the geometric analysis on the transition feature can include calculating a curvature deviation metric based at least in part on a curvature of the point cloud data and a curvature of a fitted parametric surface. Generating the fitted parametric surface for the object can include generating a surface fit confidence index color map on the fitted parametric surface.

At block 1906, the CAD engine 114 generates a fitted computer-aided drawing (CAD) surface for the object based at least in part on the transition feature of the object and results of the geometric analysis on the transition feature of the object. According to one or more embodiments described herein, generating the fitted parametric surface for the object comprises generated a new file readable by a CAD application and containing data that causes the CAD application to generate a digital representation of the object.

Additional processes also may be included. For example, the method 1900 can include performing a volumetric deviation analysis on the fitted parametric surface by comparing a volume of the point cloud data and a volume of the fitted parametric surface. It should be understood that the process depicted in FIG. 19 represents an illustration, and that other processes may be added or existing processes may be removed, modified, or rearranged without departing from the scope and spirit of the present disclosure.

It is understood that the technical solutions described herein are capable of being implemented in conjunction with any other type of computing environment now known or later developed. For example, FIG. 20 depicts a block diagram of a processing system 2000 for implementing the techniques described herein. In examples, processing system 2000 has one or more central processing units (processors) 2021a, 2021b, 2021c, etc. (collectively or generically referred to as processor(s) 2021 and/or as processing device(s)). In aspects of the present disclosure, each processor 2021 can include a reduced instruction set computer (RISC) microprocessor. Processors 2021 are coupled to system memory (e.g., random access memory (RAM) 2024) and various other components via a system bus 2033. Read only memory (ROM) 2022 is coupled to system bus 2033 and may include a basic input/output system (BIOS), which controls certain basic functions of processing system 2000.

Further depicted are an input/output (I/O) adapter 2027 and a network adapter 2026 coupled to system bus 2033. I/O adapter 2027 may be a small computer system interface (SCSI) adapter that communicates with a hard disk 2023 and/or a tape storage drive 2025 or any other similar component. I/O adapter 2027, hard disk 2023, and tape storage device 2025 are collectively referred to herein as mass storage 2034. Operating system 2040 for execution on processing system 2000 may be stored in mass storage 2034. The network adapter 2026 interconnects system bus 2033 with an outside network 2036 enabling processing system 2000 to communicate with other such systems.

A display (e.g., a display monitor) 2035 is connected to system bus 2033 by display adaptor 2032, which may include a graphics adapter to improve the performance of graphics intensive applications and a video controller. In one aspect of the present disclosure, adapters 2026, 2027, and/or 232 may be connected to one or more I/O busses that are connected to system bus 2033 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 2033 via user interface adapter 2028 and display adapter 2032. A keyboard 2029, mouse 2030, and speaker 2031 may be interconnected to system bus 2033 via user interface adapter 2028, which may include, for example, a Super I/O chip integrating multiple device adapters into a single integrated circuit.

In some aspects of the present disclosure, processing system 2000 includes a graphics processing unit 2037. Graphics processing unit 2037 is a specialized electronic circuit designed to manipulate and alter memory to accelerate the creation of images in a frame buffer intended for output to a display. In general, graphics processing unit 2037 is very efficient at manipulating computer graphics and image processing, and has a highly parallel structure that makes it more effective than general-purpose CPUs for algorithms where processing of large blocks of data is done in parallel.

Thus, as configured herein, processing system 2000 includes processing capability in the form of processors 2021, storage capability including system memory (e.g., RAM 2024), and mass storage 2034, input means such as keyboard 2029 and mouse 2030, and output capability including speaker 2031 and display 2035. In some aspects of the present disclosure, a portion of system memory (e.g., RAM 2024) and mass storage 2034 collectively store an operating system to coordinate the functions of the various components shown in processing system 2000.

The above-described technical solutions address the shortcomings of the prior art by providing improved surface representation of object compared to conventional techniques. For example, automated identification of transition features provides more efficient feature identification. Geometric analysis provides enhanced metrics, such as CDM, volume, etc., of error provide additional confidence in surface fitting accuracy. Visual representation of transition features provides improved qualitative display for faster and more accurate evaluation of large amounts of geometric data. Automatic selection of features that are likely to cause higher fitting errors provides a more efficient approach for operators to focus on areas that might be more difficult to reconstruct. Recommendations for surface control points through the CDM metric enhances conventional techniques of fit quality and manual adjustment of spline surfaces. Visual representation of curvature fit error between point cloud data and the fitted parametric surface enhances evaluation of large amounts of geometric data.

The following are some of the technical features that contribute to and provide for the advantages described above. For example, automated identification of transition features is achieved through characterization of geometric features and classification using machine learning techniques. Enhanced metrics (CDM, volume) of error are achieved through curvature comparison of PC and CAD data in multiple data points, as well as volumetric differences between PC, STL and CAD data. Visual representation of transition features is achieved by color-coded display of the earlier identified transition features. Automatic selection of transition features that are likely to cause higher fitting error is achieved by selecting from the classified features that have low probability/frequency of being classified into a known feature. Recommendation for surface control points through CDM metric is achieved by the objective function for optimizing the locations of control vertices for spline surface fitting. Visual representation of curvature fit error between PC data and the fitted parametric surface is achieved by color-coded display of the values of the objective function identified for CDM metric. These technical features represent improvements over conventional modeling techniques and therefore improve computer functionality and CAD reconstruction technologies.

Example embodiments of the disclosure include or yield various technical features, technical effects, and/or improvements to technology for reconstructing objects. Example embodiments of the disclosure provide techniques for reconstructing an object by identifying transition features using point cloud data corresponding to the object, performing a geometric analysis on the transition feature using a curvature deviation, and generating a fitted pitted parametric surface for the object based on the transition feature and the results of the geometric analysis on the transition feature. These aspects of the disclosure constitute technical features that yield the technical effect of enabling an object to be recreated more efficiently and accurately than existing CAD approaches. As a result of these technical features and technical effects, the present techniques represent improvements over conventional modeling techniques and therefore improve computer functionality and CAD reconstruction technologies. It should be appreciated that the above examples of technical features, technical effects, and improvements to technology of example embodiments of the disclosure are merely illustrative and not exhaustive.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for reconstructing an object, the method comprising:
identifying, by a processing device, a transition feature of the object based at least in part on point cloud data corresponding to the object;
performing, by the processing device, a geometric analysis on the transition feature of the object based at least in part on a curvature deviation; and
generating a fitted parametric surface for the object based at least in part on the transition feature of the object and results of the geometric analysis on the transition feature of the object.

2. The computer-implemented method of claim 1, wherein identifying the transition feature of the object comprises determining an orientation and a frequency of at least one vector associated with a facet surface of the object.

3. The computer-implemented method of claim 1, wherein identifying the transition feature of the object comprises calculating an angle deviation value between at least one vector extending perpendicularly from a facet surface of the object relative to a normal vector extending perpendicularly from a reference point on the object.

4. The computer-implemented method of claim 3, wherein the angle deviation value is one of a plurality of angle deviation values selected from the group consisting of a zero angle deviation value, a minimum angle deviation value, a maximum angle deviation value, a mean angle deviation value, and a median angle deviation value.

5. The computer-implemented method of claim 3, wherein identifying the transition feature of the object comprises classifying the transition feature of the object based at least in part on the angle deviation value.

6. The computer-implemented method of claim 5, wherein classifying the transition feature comprises classifying the transition feature as one of a smooth fillet, a smooth fillet/corner, a sharp edge, and other.

7. The computer-implemented method of claim 3, wherein classifying the transition feature comprises comparing the angle deviation value to a plurality of threshold values.

8. The computer-implemented method of claim 1, wherein identifying the transition feature of the object comprises storing a spatial distribution for the transition feature in a library of transition features.

9. The computer-implemented method of claim 8, wherein identifying the transition feature of the object comprises performing a supervised learning technique to update the library of transition features using a classifier.

10. The computer-implemented method of claim 1, wherein performing the geometric analysis on the transition feature comprises calculating a curvature deviation metric based at least in part on a curvature of the point cloud data and a curvature of a fitted parametric surface.

11. The computer-implemented method of claim 1, wherein generating the fitted parametric surface for the object comprises generating a surface fit confidence index color map on the fitted parametric surface.

12. The computer-implemented method of claim 1, further comprising performing a volumetric deviation analysis on the fitted parametric surface by comparing a volume of the point cloud data and a volume of the fitted parametric surface.

13. The computer-implemented method of claim 1, wherein generating the fitted parametric surface for the object comprises generated a new file readable by a CAD application and containing data that causes the CAD application to generate a digital representation of the object.

14. A system comprising:
a memory comprising computer readable instructions; and
a processing device for executing the computer readable instructions for performing a method for reconstructing an object, the method comprising:
identifying, by the processing device, a transition feature of the object based at least in part on point cloud data corresponding to the object;
performing, by the processing device, a geometric analysis on the transition feature of the object based at least in part on a curvature deviation; and
generating a fitted parametric surface for the object based at least in part on the transition feature of the object and results of the geometric analysis on the transition feature of the object.

15. The system of claim 14, wherein identifying the transition feature of the object comprises determining an orientation and a frequency of at least one vector associated with a facet surface of the object.

16. The system of claim 14, wherein identifying the transition feature of the object comprises calculating an angle deviation value between at least one vector extending perpendicularly from a facet surface of the object relative to a normal vector extending perpendicularly from a reference point on the object.

17. The system of claim 16, wherein the angle deviation value is one of a plurality of angle deviation values selected from the group consisting of a zero angle deviation value, a minimum angle deviation value, a maximum angle deviation value, a mean angle deviation value, and a median angle deviation value.

18. The system of claim 16, wherein identifying the transition feature of the object comprises classifying the transition feature of the object based at least in part on the angle deviation value.

19. The system of claim 18, wherein classifying the transition feature comprises classifying the transition feature as one of a smooth fillet, a smooth fillet/corner, a sharp edge, and other.

20. A computer program product comprising:
a computer readable storage medium having program instructions embodied therewith, the program instructions executable by a processing device to cause the processing device to perform a method for reconstructing an object, the method comprising:
identifying, by the processing device, a transition feature of the object based at least in part on point cloud data corresponding to the object;
performing, by the processing device, a geometric analysis on the transition feature of the object based at least in part on a curvature deviation; and
generating a fitted parametric surface for the object based at least in part on the transition feature of the object and results of the geometric analysis on the transition feature of the object.
